(19) United States
(12) Patent Application Publication
(10) Pub. No.: US 2004/0076434 A1
(43) Pub. Date: Apr. 22, 2004

(54) Optical distribution network for RF and other analog signals

(76) Inventors: G. Allan Whittaker, Alpharetta, GA (US); Michael Gregory Abernathy, Ellijay, GA (US); Wilber Andrew Williams, Acworth, GA (US); Jimmy Carver, Woodstock, GA (US); Louis Stephen Macknik, Canton, GA (US)

Correspondence Address: JOHN S. PRATT, KILPATRICK STOCKTON LLP (LOCKHEED), 1100 PEACHTREE STREET, SUITE 2800, ATLANTA, GA, 30309, US

(21) Appl. No.: 10/283,415

(22) Filed: Oct. 29, 2002

Related U.S. Application Data
(60) Provisional application No. 60/414,747, filed on Sep. 27, 2002.

(51) Int. Cl. H04J 14/02

(52) U.S. Cl. 398/69; 398/66

(57) ABSTRACT

An optical network has an optical bus interconnecting a plurality of sources with a plurality of loads. Each source has a tunable laser for transmitting signals at a selective wavelength and each load has a tunable filter for receiving signals at a selective wavelength. As a result, through a single connection per node and a single bus, each source can exchange signals with any load. The optical network employs a passive optical interface device for routing signals between a node and a bus. The optical interface device provides balanced amplification of the optical signals throughout the network. The optical network is able to distribute RF and other analog signals to multiple nodes while preserving signal quality.

### CROSS REFERENCE TO RELATED APPLICATIONS

This application claims priority to, and incorporates by reference, co-pending provisional patent application Serial No. 60/414,747, filed on Sep. 27, 2002, entitled “Optical Distribution Network for RF and Other Analog Signals.”

### FIELD OF THE INVENTION

This invention relates generally to an optical distribution network and, more particularly, to an optical network for distributing RF and other analog signals.

### BACKGROUND

Many networks are designed to carry analog signals. One common type of analog signal is a radio frequency (RF) signal. For example, mobile radio telephone networks operate in the RF bandwidth and these signals are transmitted and received from cellular towers. The RF signals travel down the tower to a base station where they are processed before being sent to a mobile switching center (MSC). Another example of an analog distribution network is a coaxial cable distribution network for television signals.

There are many challenges associated with distributing RF and other analog signals. For example, when directing signals to multiple loads, a splitter is typically used to direct the signals to these multiple loads. In splitting the signal, however, careful attention must be paid to avoid any impedance mismatch between the lines. An impedance mismatch causes reflections in the signal which travel back up the line and which may cause interference with the transmission equipment. Splitting the line may also result in distortion in the phase of the signals which may result in the loss of data in phase modulated signals. The coaxial lines themselves introduce losses and these losses are magnified by the use of splitters. In addition, noise can be induced upon the coaxial lines signals from electromagnetic fields generated by neighboring sources, resulting in additional signal loss. As is apparent from the description above, an RF distribution network must be carefully designed and must consider impedance mismatches, phase matching, losses, and reflections.

Additional challenges are introduced in the design of an RF distribution network when the network contains multiple sources and multiple loads. For example, a single source that is delivered to ten loads requires at least ten cables to deliver the signals to each load as well as a number of splitters. As described above, each split in the line must take into consideration impedance mismatching, phase matching, reflections, and signal losses. If this network is changed so that it now has ten sources, each of which provides its signals to ten loads, then the complexity of the network is increased by an order of magnitude. Instead of at least ten cables, the network now requires at least a hundred cables to interconnect each source to each load.

An optical distribution network solves several of the problems associated with an electrical distribution network. The losses in optical fiber are significantly less than those in a coaxial cable. Often, the optical network comprises a wavelength division multiplexed network in which wavelengths are allocated to the various sources. The loads then have wavelength division multiplexers for selecting a desired wavelength and thus a desired source. This type of network is very similar to a point-to-point network topology when the number of loads is equal to the number of sources. This wavelength division multiplexed approach is rather static and cannot easily accommodate changes in the network. For instance, if a load needs the signal from a different source, the wavelength division multiplexer would need to be reconfigured to provide the wavelength allocated to that source. Also, it is difficult to add wavelengths, sources, or loads when wavelengths are assigned to the transmitters at the sources and the loads are assigned specific wavelengths.

### SUMMARY

The invention addresses the problems above by providing systems, networks, and methods for distributing optical signals. The optical networks include an optical medium for carrying optical signals, which preferably comprises an optical fiber but may include other media, such as optical waveguides and over-the-air transmission. The optical network includes an optical interface device for passively routing optical signals to each note within the network. The optical interface device may comprise a wavelength division multiplexer (WDM) but preferably comprises an optical tap for diverting a fraction of all the signals to the node. The optical interface device not only diverts signals traveling along both directions of the optical bus to each node but also forwards optical signals originating from a node onto the bus in both directions. The preferred optical interface device also provides balanced amplification of optical signals such that the optical signals entering one port of the optical interface device exit all other ports of the optical interface device at the same signal level. Additional details of the optical interface device may be found in co-pending patent application Ser. No. 60/414,746 entitled “Optical Interface Device Having Balanced Amplification,” filed on Sep. 27, 2002, and later filed non-provisional patent application Ser. No. ______, entitled “Optical Interface Device Having Balanced Amplification.”

The optical network according to a preferred embodiment of the invention can be dynamically reconfigured. According to one aspect, the sources have tunable lasers whereby each source can alter a wavelength of transmission. According to another aspect, the loads have tunable filters so that each load can selectively receive signals from any source. According to yet a further aspect, the sources have transmitters that can tune to different wavelengths and the sources have filters that can select from any wavelength. As a result, any load can receive signals from any source and, vice versa, and any source can transmit signals to any load.

The optical network preferably has some capability of transmitting control signals between the sources and the loads. These control signals may be transmitted as part of the overhead in the signals exchanged between the sources and the loads or the control signals may be sent along a dedicated channel established between the sources and the load. With this dedicated channel, each load can receive the control signals assigned to one wavelength of light as well as signals from the sources that are assigned to at least one other wavelength of light.

The optical networks according to the invention are well suited for the distribution of analog and other RF signals. By their very nature, analog signals convey information through the waveform of the signals. For instance, for amplitude modulation, the magnitude of the signal is used to convey information. In a similar manner, the frequency, phase, or polarization of an analog signal can be modulated to convey information. Thus, in distributing analog signals, the analog signal that is transmitted at a source should be a precise duplicate in every manner of the signal that is detected at any of the loads. The optical networks according to the invention, in part due to the balanced amplification within the optical interface devices, allow for an efficient and practical solution to distributing analog signals.

Conventional approaches to distributing RF signals involve the use of a line between each source and each load. Thus, for one source to transmit signals to each of ten loads, the network would require ten lines. This approach suffers from a disadvantage of requiring an increasing number of lines for each additional load or source. The optical networks according to the invention, on the other hand, may operate with as little as one optical bus which carries signals from all sources to all loads. The optical networks according to the invention, therefore, drastically reduce the number of lines required and eliminate any need for complicated switching between sources and loads.

The optical networks may be used in practically any environment. For example, the optical networks are well adapted for use in a wireless network which requires the transmission of RF or other analog signals. For instance, optical networks may carry signals between the antennas on a tower and the base station or a central processing station. In addition, optical networks may carry signals between a base station and one or more central processing stations, a base station to one or more base stations, and a central processing station and one or more central processing stations. As another example, optical networks may be used in the distribution of television signals from a broadcasting source or head-end unit to multiple receivers, each of which can selectively tune in a desired channel. Other examples are provided in the description below and will become apparent to those skilled in the art.

Other advantages and features of the invention will be apparent from the description below, and from the accompanying papers forming this application.

### BRIEF DESCRIPTION OF DRAWINGS

The accompanying drawings, which are incorporated in and form a part of the specification, illustrate preferred embodiments of the present invention and, together with the description, disclose the principles of the invention. In the drawings:

FIG. 1 is a diagram illustrating a conventional approach to interconnecting a number of nodes within a network;

FIG. 2 is a diagram illustrating an optical network according to an embodiment of the invention;

FIG. 3 is a graph illustrating a difference in the number of connections required versus the number of users between the network of FIG. 1 and the optical network of FIG. 2;

FIG. 4 is a more detailed network diagram illustrating a conventional networking approach;

FIG. 5 is a more detailed network diagram illustrating an optical network according to an embodiment of the invention;

FIG. 6 is a more detailed diagram of an optical interface device illustrated in FIG. 5;

FIG. 7 is another exemplary diagram of an optical network according to an embodiment of the invention;

FIG. 8 is still a further exemplary diagram of an optical network according to an embodiment of the invention; and

FIG. 9 is yet another example of an optical network according to an embodiment of the invention incorporating control for signal level.

### DETAILED DESCRIPTION

I. Overview

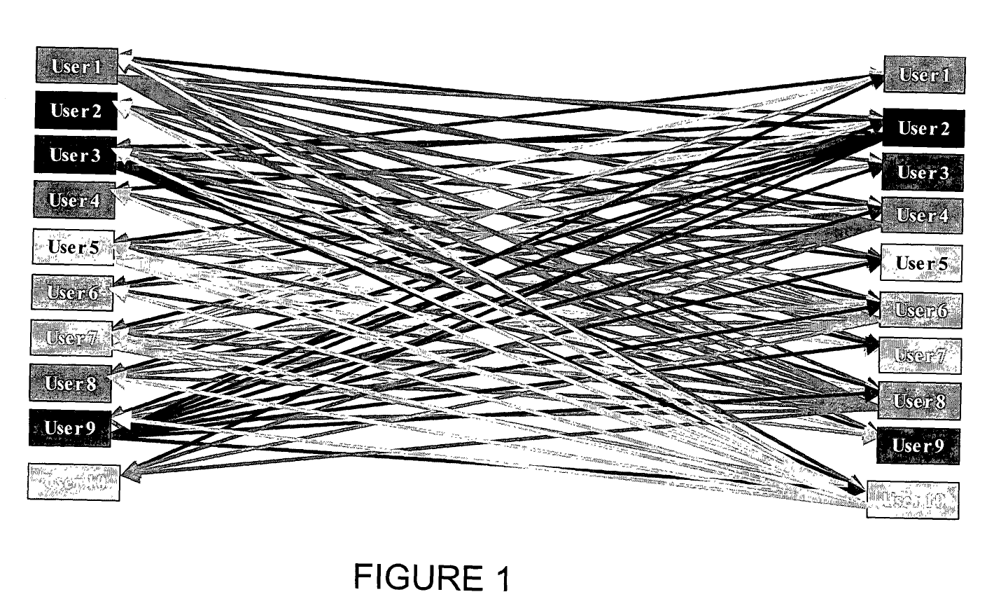

As mentioned above, one challenge in a network is in providing signals from a number of sources to a number of loads. This problem is illustrated in FIG. 1 with ten users. In this example, each user needs to transmit to each of the other nine users as well as to receive signals from each of the other nine users. The arrows between the users represent the transmission of signals between each pair of users. As is apparent from the figure, the number of channels required to accommodate all of these transmissions becomes quite large, even for the small number of 10 users in this example. One approach to carrying all these channels is to employ a line interconnecting each source to each load. As explained in the Background, this approach would require 90 lines for 10 sources and 10 loads. Another approach is to provide a switch, which in this example would be a 10×9 switch, which would then provide the necessary connections between sources and loads.

With some types of signals, either of the solutions outlined above may be practical in terms of cost and performance. For high frequency signals and analog signals, such as radio frequency (RF) signals, both of these approaches are often impractical. For one, a network would become unnecessary complex to properly manage reflections, impedance matching, phase matching, and losses. A switch approach would reduce the number of lines required, but at a significant cost. Even a small switch, such as a 3×3 switch, has an exorbitant cost that can be justified in only rare situations.

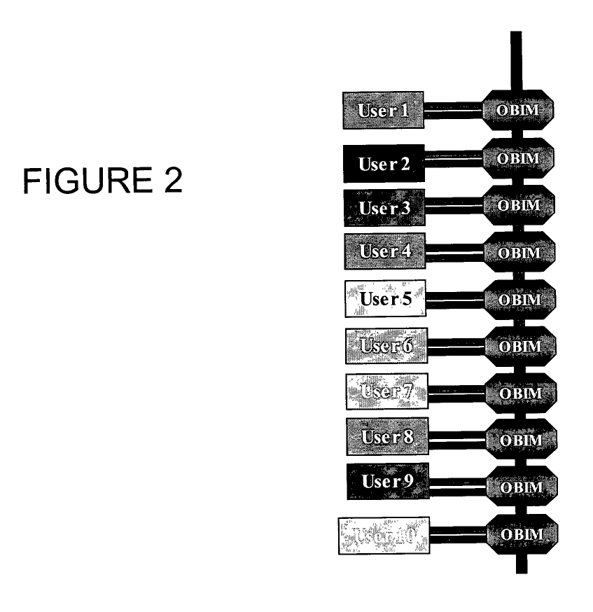

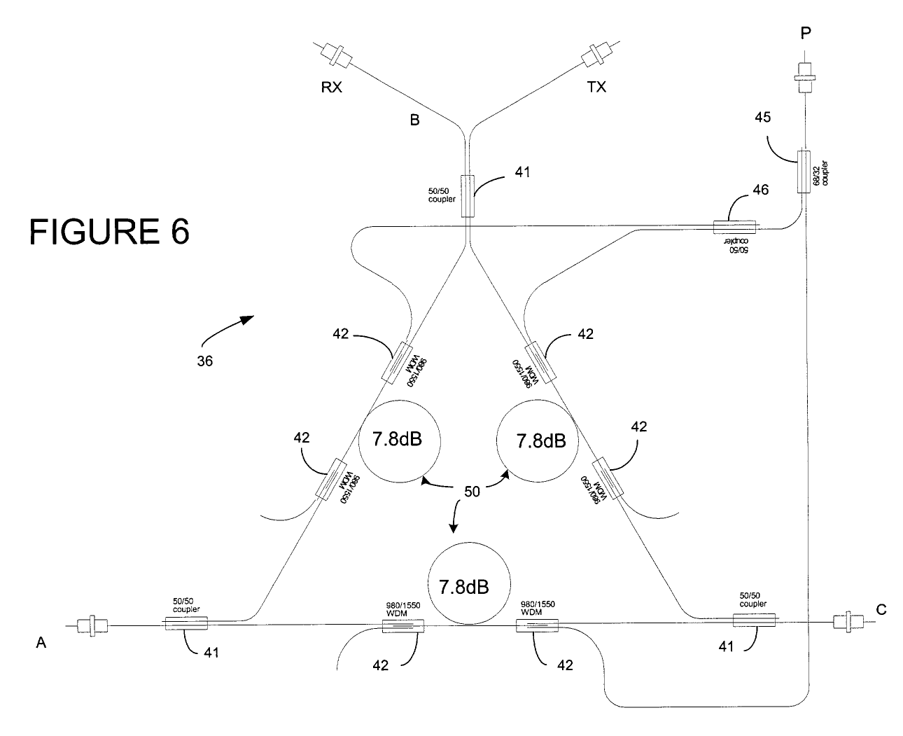

FIG. 2 illustrates the simplicity associated with optical networks according to the invention. As illustrated in this figure, instead of multiple lines interconnecting each user with every other user, each user is connected to a common bus through an optical interface device (OID). The OID, also referred to as an optical bus interface module (OBIM), in general directs signals originating from a user onto the bus in both directions and routes signals traveling along the bus in either direction to each user. The OBIM is a passive device in that it does not convert the optical signals into electrical signals nor does it transform optical signals into other optical signals like add-drop during the routing process. The preferred OBIM is described in co-pending U.S. patent application Ser. No. 60/414,746 entitled “Optical Interface Device Having Balanced Amplification,” filed on Sep. 27, 2002, and later filed non-provisional patent application Ser. No. ______, entitled “Optical Interface Device Having Balanced Amplification,” both of which are incorporated by reference. Additional details of the OBIM may be found in the co-pending patent application as well as in the description associated with FIG. 6.

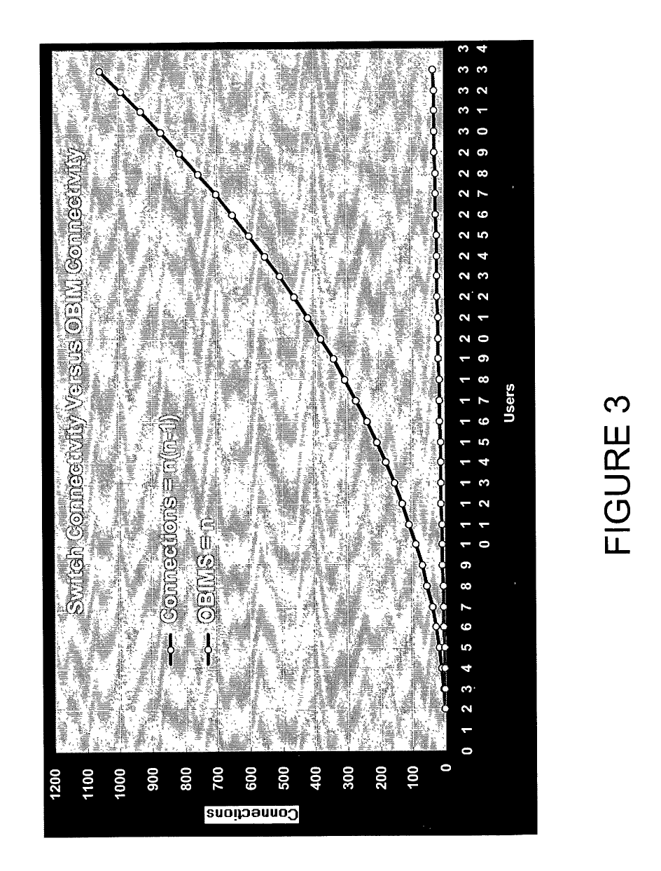

The benefits of optical networks according to the invention are highlighted in FIG. 3. FIG. 3 illustrates the number of connections required based on the number of users within a network. The plot with an increasing slope is for a conventional approach wherein the number of connections is equal to the product of n*(n−1). In contrast, the number of required connections using OBIMs with optical networks according to the invention is equal to n. As one example, with 20 users, an optical network according to the invention would require 20 connections whereas the conventional approach outlined above would require 380 connections. The optical networks according to the invention therefore greatly simplify the design of optical networks and substantially reduce the cost associated with exchanging signals between multiple sources and loads, while improving performance and enhancing the fidelity of the transmitted signal.

II. Network Examples

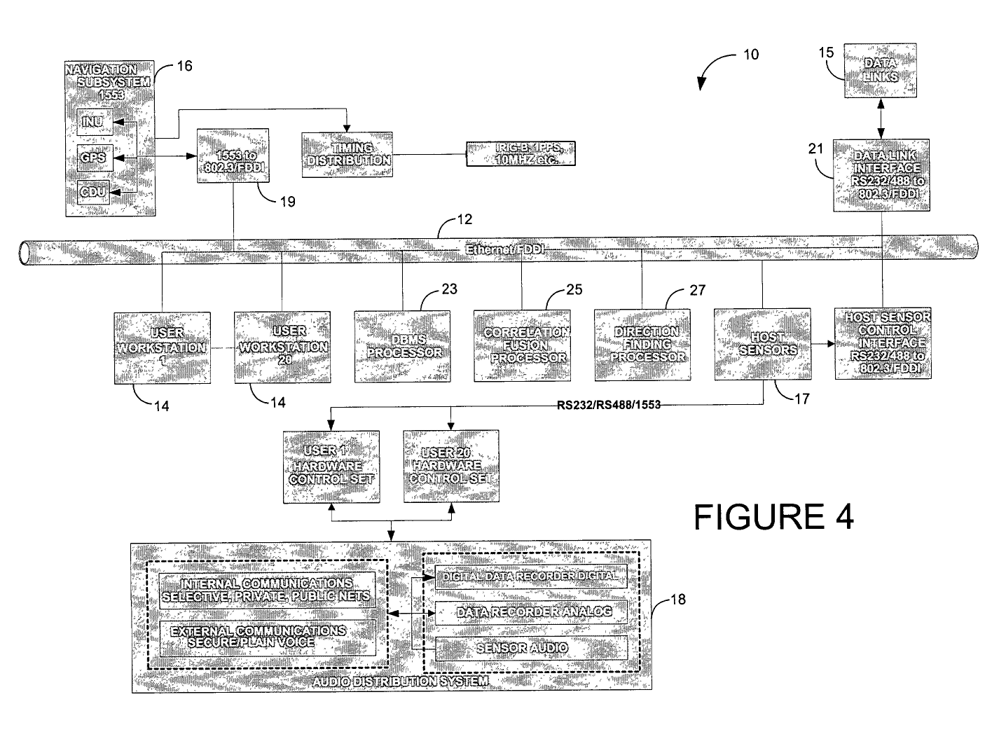

FIG. 4 illustrates a network 10 that may be provided on aircraft. This network 10 includes a backbone 12, such as an Ethernet/Fiber Distributed Data Interface (FDDI). Off of this backbone 12 are numerous nodes, including a plurality of user work stations 14. The network in FIG. 4 must address the complexity of either the collisions on an Ethernet bus network or the switches for a switched Ethernet network. The network also includes complexity of two fiber point-to-point connections between FDDI interfaces that perform optical-to-electrical-to-optical conversions to make the FDDI ring functional. The network 10 also includes a navigational system 16 as well as an audio distribution system 18. Furthermore, the network 10 includes data links 15 and sensor arrays 17. As noted in the figure, many of these nodes operate with different type of media and with different protocols. For instance, the navigation system 16 transmits Mil Std. 1553 which is translated into 802.3/FDDI through interface 19. The data links 15 have an RS 232/488 output which passes through an interface 21 while other nodes transmit analog signals. In addition to data signals, the network 10 also distributes control signals for controlling remote processes. For example, the network 10 has a DBMS processor 23, a correlation/fusion processor 25, and a direction finding processor 27. The different types of media, the different protocols, and the different types of signals themselves all render it rather difficult to move data in a distributed fashion throughout the network 10.

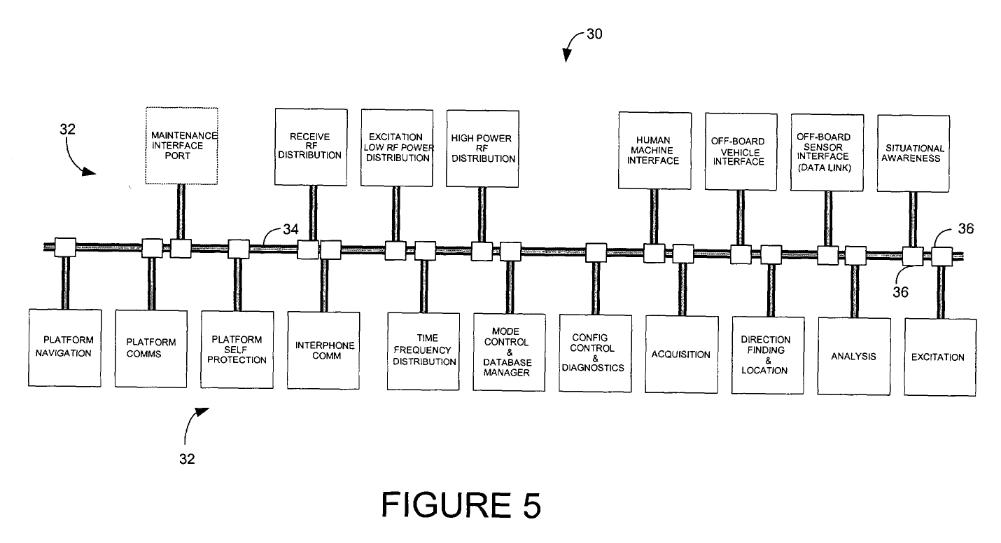

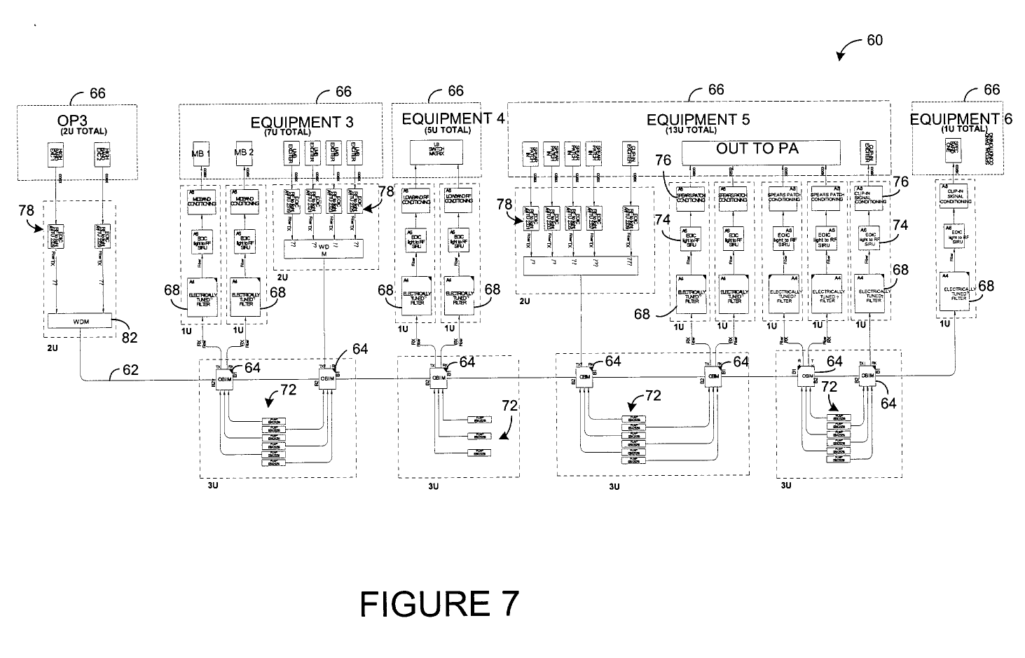

FIG. 5 illustrates a preferred network 30 according to an embodiment of the invention having a plurality of nodes 32 connected to a bus 34 through an optical interface device 36, which is preferably an OBIM. This network 30 shown in FIG. 5 is able to facilitate the integration of multiple media 802.3, FDDI, RS232, RS432, RS488, Mil Std. 1553, as well as other digital or analog signals. The network 30 also enables the control of remote processes and overall moves data in a bidirectional distributed fashion throughout the network 30 from any node 32 to any other node 32. The network 30 shown in FIG. 5 greatly simplifies the design of a network 30 and is easily altered by adding or removing nodes 32. Further advantages of the network will become apparent from the description associated with FIG. 7.

III. OBIM

FIG. 6 provides a more detailed diagram of an OBIM 36 according to a preferred embodiment of the invention. The OBIM 36 may be fabricated with any technology. FIG. 6 provides an example of the OBIM 36 fabricated using discrete components. The OBIM 36 has three ports A, B, and C. A 50/50 coupler 41 is positioned at each port and splits the incoming signal into two equal components that are directed along one of the three legs within the OBIM 36. Thus, each leg of the OBIM 36 interconnects one of the ports to the other two ports. The 50/50 couplers 41 at each port also combine the signals traveling in the opposite direction along the legs which originate from the two other ports.

For example, a signal entering port A is divided into two components A1 and A2 by the 50/50 coupler 41 with component A1 traveling to port B and component A2 traveling to port C. Similarly, a signal B at port B is divided into components B1 and B2 by the 50/50 coupler 41 at port B and a signal C at port C is divided into components C1 and C2 by the 50/50 coupler 41 at port C. The 50/50 coupler 41 at port A combines the signals B1 and C1 and route them so they exit port A. Similarly, the 50/50 coupler 41 at port B combines the signals A1 and C2 and route them so they exit port B and the 50/50 coupler 41 at port C combines the signals A2 and B2 and route them so they exit port C.

Each leg provides for bi-directional amplification of the optical signals. The OBIM 36 has fiber amplifiers 50 and, more preferably rare earth doped fiber amplifiers, such as erbium doped fiber amplifiers. The amplifiers 50 preferably amplify the optical signals by 7.8 dB. This amplification compensates for the 6 dB splitting loss resulting from the 50/50 coupler 41 as well as an additional 1.8 dB loss from losses associated with coupling each port of the OBIM 36 to a fiber line. Because the coupling losses associated with the OBIM 36 will vary with the precise couplers used and the optical medium to which the OBIM 36 is coupled, the precise amount of amplification provided by the fiber amplifiers 50 may vary.

The fiber amplifiers 50 receive an excitation light from a pump P that is divided into three essentially equal components and provided to each leg through a 68/32 coupler 45 and a 50/50 coupler 46. The excitation light is coupled to each leg of the OBIM 36 through couplers 42, which are preferably wavelength division multiplexers 42. The excitation light in this example is at 980 nm while the optical signals have wavelengths of light within the 1550 nm window.

The OBIM 36 shown in FIG. 6 is just one non-limiting example of how the OBIM 36 may be fabricated. In addition to using discrete components, the OBIM 36 may be fabricated using semiconductor technology, through polymers, ion migration, and other existing or future developed techniques.

IV. Detailed Network Diagram

FIG. 7 illustrates a more detailed diagram of a network 60 according to another embodiment of the invention. The network 60 includes a fiber optic bus 62 and a plurality of optical interface devices 64 for routing optical signals between the bus 62 and a plurality of nodes 66. These nodes 66 are labeled OP3, Equipment 3, Equipment 4, Equipment 5, and Equipment 6. Networks according to the invention may include additional or fewer nodes which are configured in other ways. The optical interface devices 64 are preferably the OBIMs 36 shown in FIG. 6. The network 60 also includes a wavelength division multiplexer (WDM) or electrically tuned filters 68 for selecting desired wavelengths from the optical bus 62. The OBIMs 64 receive an excitation light from one or more pumps 72 for performing the bidirectional amplification of the signals.

One feature of the network 60 shown in FIG. 7 is the ability for nodes 66 to selectively receive signals at different wavelengths of light. For instance, the Equipment 5 node 66 comprises units with electrically tuned filters for selecting a desired wavelength of light and an electrical to optical interface card (EOIC) 74 for converting those optical signals into electrical signals. The electrical signals are then provided to terminal equipment 76 for various uses. On the transmission side, the optical signals are transmitted by lasers 78 at different wavelengths of light and inserted onto the bus 62. These laser 78 may transmit at fixed wavelengths whereby the loads must tune to a desired source. Alternatively, the lasers 78 can tune to a desired wavelength and thus transmit at any one of a plurality of wavelengths. According to this aspect, the sources can adjust its wavelength of transmission to send optical signals to a desired load.

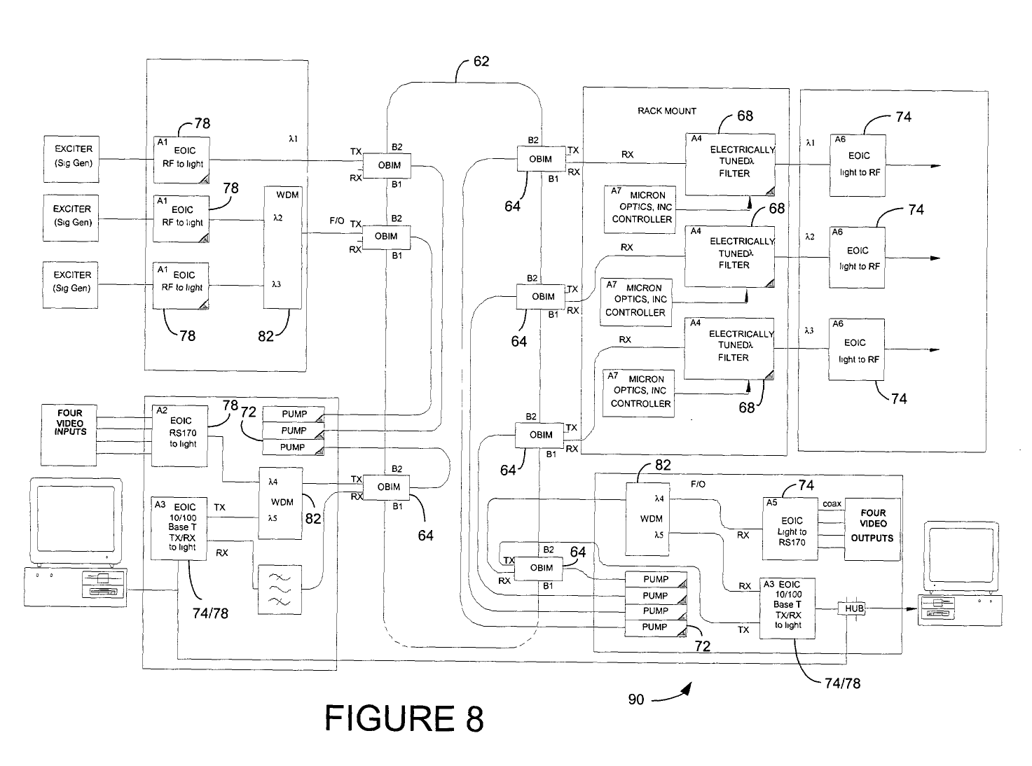

The optical signals may be directly coupled onto the bus 62 or may be joined with other signals through a WDM 82 and these combined multiplexed signals are then directly coupled onto the bus 62. An advantage of the network 60 shown in FIG. 7 is that a load may receive signals from any source by selectively tuning a filter 68 to the corresponding wavelength. With tunable lasers, the converse is also true in that each source can adjust its wavelength so that it transmits to a desired load. FIG. 8 illustrates another example of a network 90 according to an embodiment of the invention.

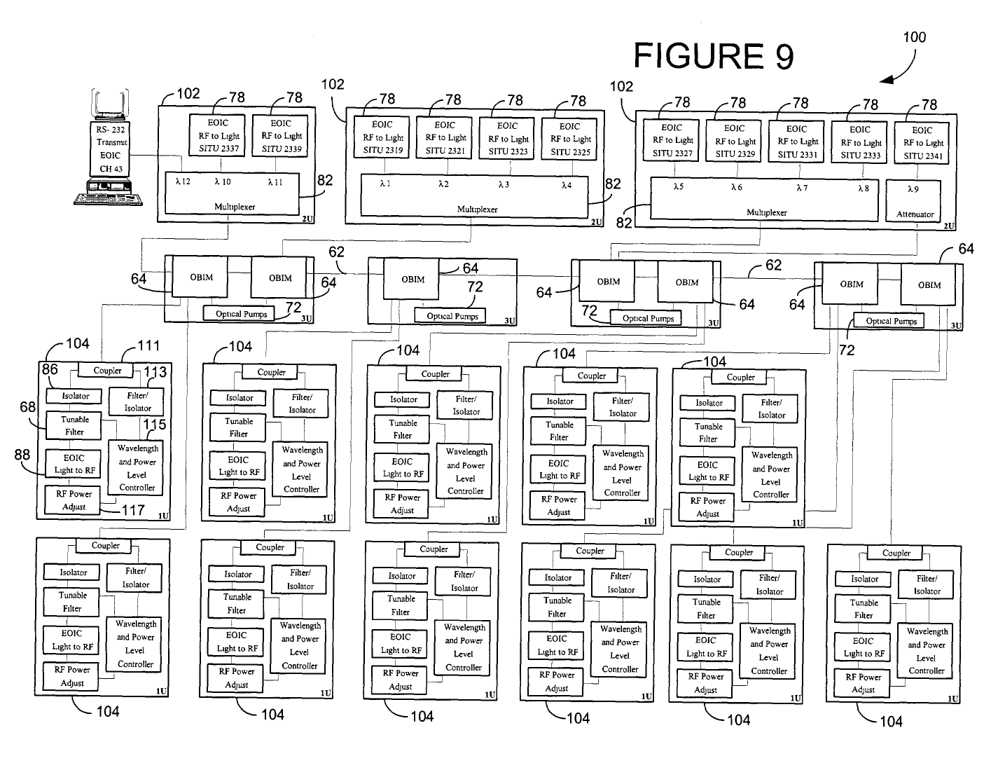

FIG. 9 is yet another example of an optical network 100 according to an embodiment of the invention. The optical network 100 shown in FIG. 9 differs from other embodiments in that it is able to better monitor and control the power level of optical signals. Sources 102 in this example transmit a reference signal having a known signal level to loads 104. The loads 104 detect the reference signal and compare the power level to a predetermined reference level. Based on any difference between the power levels, the load 104 is able to adjust detected communication signals accordingly.

With reference to FIG. 9, the reference signal is transmitted and detected by each of the loads (1U) 104. At the load 104, a coupler 111 directs a portion of the signal to a filter/isolator 113 which isolates the reference signal. A wavelength and power level controller 115 then detects the power level and compares the level to the reference level. Based on any discrepancy, the wavelength and power level adjuster 115 controls an RF Power Adjust unit 117 so that detected signals are at the proper level. The optical signals are directed from the coupler 111 to an isolator 86, to the tunable filter 68, and then to an EOIC light to RF unit 88 which converts the optical signals into electrical signals.

The wavelength and power level controller 115 can also function to adjust the tunable filter to a desired wavelength. In addition to receiving the reference signal, the wavelength and power level controller 115 can also receive a control signal from which the wavelength and power level controller 115 can determine the desired wavelength. For instance, a source 102 seeking to transmit signals to one of the loads 104 inserts a command onto the control signal and this control signal is received at the desired load 104. The control signal specifies what wavelength the load 104 should select in order to receive optical signals from that source 102. In addition to sending control signals from loads to sources, the optical networks according to the invention may be bi-directional in that control signals and other communications may be sent from the loads to the sources. With this bi-directional exchanges of control signals, the loads 104 may request that the sources 102 transmit optical signals at a particular wavelength. Other uses of control signals will be apparent to those skilled in the art.

V. Environments

The optical networks according to the invention may be used in a variety of different environments. For instance, the optical networks may be used in distributing signals from a wireless network. A mobile radiotelephone tower may receive RF signals from mobile devices and the networks convert those signals directly into optical signals which are then routed through an optical bus to a base station and/or central processing station. Thus, rather than having a base station associated with each tower, a central processing station may receive signals directly from multiple towers and perform processing in a coordinated fashion. The wireless signals need not be downconverted but can be converted directly into RF signals and these analog RF optical signals then distributed throughout the network. The OBIM shown in FIG. 6 greatly assists in distributing these analog signals by maintaining signal quality.

As another example, optical networks may be used in distributing signals for display by a television. These signals may be received by a cable head end and/or a satellite receiver. The signals may be transmitted in a digital or analog format. As with the example given above, the OBIMs shown in FIG. 6 enable the distribution of analog TV signals without incurring significant deterioration in signal levels or quality. The subscribers to the service may have receivers which selectively tune to any wavelength, and thus to any channel.

As another example, the optical networks may be used in In-Flight Entertainment, such as on commercial aircraft. The IFE example and cable distribution example enable the capability of video-on-demand. Through the ability to transmit at any wavelength and also receive signals at any wavelength, the loads can coordinate with the sources so that the desired programming is delivered to that load.

As mentioned above with all examples, the optical networks can operate according to different protocols and media. The optical network may also operate according to an encapsulation method described in co-pending patent application Ser. No. 09/924,037, entitled “Physical Layer Transparent Transport Information Encapsulation Methods and Systems,” filed on Aug. 7, 2001, which is incorporated herein by reference.

The foregoing description of the preferred embodiments of the invention has been presented only for the purpose of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated.

What we claim:

1. An optical network for distributing optical signals between loads and sources, comprising:
an optical bus for carrying the optical signals between the loads and sources; and
an optical interface device located along the optical bus, each optical interface device routing optical signals between the optical bus and at least one of the load or the source,
each optical interface device comprising:
a first port connected to the optical bus for receiving optical signals traveling along the optical bus in a first direction;
a second port connected to the optical bus for receiving optical signals traveling along the optical bus in a second direction, the second direction being opposite the first direction;
a third port for routing optical signals between the optical bus and the at least one of the load or the source;
a first coupler for splitting optical signals received from the first port into a plurality of optical signal components and for routing one of the optical signal components to each of the second and third ports;
a second coupler for splitting optical signals from the second port into a plurality of optical signal components and for routing one of the optical signal components to each of the first and third ports;
a third coupler for splitting optical signals from the third port into a plurality of optical signal components and for routing one of the optical signal components to each of the first and second ports;
a first optical amplifier located between the first and second ports for amplifying optical signals routed between the first and second ports;
a second optical amplifier located between the second and third ports for amplifying optical signals routed between the second and third ports;
a third optical amplifier located between the first and third ports for amplifying optical signals routed between the first and third ports;
wherein each of the first, second, and third optical amplifiers has a gain that is sufficient to compensate for coupling losses associated with the first, second, and third ports, respectively, and splitting losses associated with the first, second, and third splitter, respectively.

2. The optical network as set forth in claim 1, wherein the first, second, and third amplifiers comprise fiber amplifiers.

3. The optical network as set forth in claim 1, wherein the first, second, and third couplers comprise 50/50 splitters.

4. The optical network as set forth in claim 1, wherein the optical bus comprises an optical fiber.

5. The optical network as set forth in claim 1, wherein the optical interface device routes optical signals between the optical bus and one of the sources.

6. The optical network as set forth in claim 1, wherein the optical interface device routes optical signals between the optical bus and a plurality of sources.

7. The optical network as set forth in claim 1, wherein the optical interface device routes optical signals between the optical bus and one of the loads.

8. The optical network as set forth in claim 1, wherein the optical interface device routes optical signals between the optical bus and a plurality of sources.

9. The optical network as set forth in claim 1, wherein the optical interface device routes optical signals between the optical bus and one of the sources and one of the loads.

10. The optical network as set forth in claim 1, further comprising a wavelength division multiplexer for combining optical signals from multiple sources and for routing a wavelength division multiplexed signal onto the optical bus.

11. The optical network as set forth in claim 10, wherein the optical interface device receives the wavelength division multiplexed signal and routes the wavelength division multiplexed signal onto the optical bus.

12. The optical network as set forth in claim 10, wherein the wavelength division multiplexer places the wavelength division multiplexed signal directly onto the optical bus.

13. The optical network as set forth in claim 1, further comprising a wavelength division multiplexer for receiving a wavelength division multiplexed signal from the optical bus and for routing optical signals at different wavelengths to multiple loads.

14. The optical network as set forth in claim 13, wherein the wavelength division multiplexer receives the wavelength division multiplexed signal from the optical interface device.

15. The optical network as set forth in claim 1, wherein the optical bus and the optical interface devices route analog optical signals.

16. The optical network as set forth in claim 1, wherein the optical bus and the optical interface devices route radio frequency analog optical signals.

17. The optical network as set forth in claim 1, wherein the optical interface devices provide balanced optical amplification of the optical signals so that optical signals entering one of the first, second, or third ports exits the other two of the first, second, and third ports at the same signal level.

18. The optical network as set forth in claim 1, further comprising an electrical to optical converter for receiving electrical signals, for generating corresponding optical signals, and for providing the optical signals to the third port of the optical interface device.

19. The optical network as set forth in claim 1, further comprising an optical to electrical converter for receiving optical signals from the third port of the optical interface device, for generating corresponding electrical signals, and for providing the electrical signals to terminal equipment.

20. The optical network as set forth in claim 1, wherein the optical bus and the optical interface devices route radio frequency analog optical signals.

21. The optical network as set forth in claim 1, further comprising a tunable filter for receiving the optical signals from the third port and for selecting optical signals at a desired wavelength.

22. The optical network as set forth in claim 21, further comprising a controller for adjusting the wavelength at which the tunable filter selects the desired optical signals.

23. The optical network as set forth in claim 1, wherein the sources transmit control signals to the loads, the controller receiving the control signals and adjusting the wavelength at which the tunable filter based on the control signals.

24. The optical network as set forth in claim 1, wherein the sources comprise a tunable transmitter for emitting optical signals at any one of a plurality of wavelengths.

25. The optical network as set forth in claim 1, wherein the loads transmit control signals to the sources, the sources adjusting the wavelength at which the transmitter emits optical signals based on the control signals.

26. An optical network for distributing optical signals between loads and sources, comprising:
an optical bus for carrying the optical signals between the loads and sources; and
an optical interface device located along the optical bus, each optical interface device routing optical signals between the optical bus and at least one of the load or the source,
each optical interface device comprising:
means for receiving an optical signal from the optical bus at a first port;
means for separating the optical signal into a plurality of signal components;
means for amplifying the optical signal components to compensate for losses associated with the receiving means and the separating means, the amplifying means generating amplified optical signal components; and
means for passing the amplified optical signal components onto the optical bus at a second port and to a third port.

27. A method of distributing optical signals, comprising:
receiving optical signals from a plurality of sources;
passively directing the optical signals from each source onto the optical bus through optical interface devices;
distributing the optical signals from the sources to a plurality of loads;
passively routing the optical signals from the optical bus to each load through the optical interface devices;
amplifying the optical signals traveling along the optical bus at each optical interface device;
wherein amplifying the optical signals comprises providing sufficient gain to compensate for losses associated with passively directing the optical signals from the sources onto the optical bus and for losses associated with passively routing the optical signals to each load.
